(19) United States
(12) Patent Application Publication
(10) Pub. No.: US 2002/0049635 A1
(43) Pub. Date: Apr. 25, 2002

(54) Multiple advertising

(76) Inventors: Khanh Mai, Alpharetta, GA (US); Roland Noll, Columbia, MD (US); Tom Grimes, Ottawa (CA)

Correspondence Address: DORSEY & WHITNEY, 1001 PENNSYLVANIA AVE., N.W., SUITE 300 SOUTH, WASHINGTON, DC, 20004, US

(21) Appl. No.: 09/946,368

(22) Filed: Sep. 6, 2001

Related U.S. Application Data
(60) Provisional application No. 60/230,454, filed on Sep. 6, 2000.

(51) Int. Cl. G06F 17/60

(52) U.S. Cl. 705/14

(57) ABSTRACT

A method and apparatus for delivering multiple advertising for display with high-bandwidth content. The method and apparatus deliver multiple advertising to client computers in a flexible and customizable manner. The method and apparatus deliver multiple advertising by receiving multiple advertising at a client via a broadband medium and displaying high-bandwidth content at the client. The multiple advertising includes a package of a plurality of advertisements and the high-bandwidth content is of a form chosen from a list consisting of: video, audio, text, and a combination thereof. The method and apparatus customize the multiple advertising by evaluating a correlation between each of the advertisements of the multiple advertising and the displayed high-bandwidth content or a user profile of a user at the client and ranking each advertisement of the multiple advertising based on the correlation of each advertisement and the displayed high-bandwidth content or the user profile.

### CROSS REFERENCE TO RELATED APPLICATIONS

This application hereby claims the benefit of the priority of U.S. Provisional Patent Application, Serial No. 60/230,454, filed Sep. 6, 2000, which is hereby incorporated by reference. This application also hereby incorporates by reference U.S. patent application Ser. No. 09/835,529, entitled “Channel Dancer” and filed Apr. 17, 2001, U.S. patent application Ser. No. 09/878,232, entitled “Personal Content Manager” and filed Jun. 12, 2001, U.S. patent application Ser. No. 09/893,634, entitled “Virtual Multicasting”, and filed Jun. 29, 2001, U.S. patent application Ser. No. 09/893,635, entitled “Digital Rights Management”, and filed Jun. 29, 2001, U.S. patent application Ser. No. 09/902764, entitled “Credit System”, and filed Jul. 12, 2001, and U.S. patent application Ser. No. 09/911,794, entitled “Branded Channel”, and filed Jul. 25, 2001.

### BACKGROUND

1. Technical Field

The present invention is related to multimedia advertising, and more particularly to the filtered delivery of multimedia advertising.

2. Description of Related Art

Over the past ten years, the bandwidth capacity available to consumers for receiving content from the Internet and other networks has increased ten-fold and more. The increased bandwidth capacity has enabled consumers to download larger and larger files and other content, including rich media and multimedia broadband content such as audio clips, video clips, songs, programs and movies (collectively, content). This increased bandwidth capacity has increased Internet usage and the potential for enjoyable and productive usage.

Despite the increased bandwidth, relatively little creativity has gone into packaging content. The increased bandwidth enables many different manners of packaging multimedia advertising with high bandwidth content. Advertisers and content providers have yet to take advantage of the increased bandwidth in order to provide flexible advertising packages that may be tailored or customized to individual users and to the content with which the advertising is displayed.

### SUMMARY OF THE INVENTION

An advantage of the present invention is that it overcomes the disadvantages of the prior art. The present invention provides a method and system for delivering multimedia, multiple advertising to client computers in a flexible and customizable manner. The present invention enables advertisers to provide packages of advertising that are tailored to individual users and that may be stored on client computers for later display with multiple content items. The present invention enables the stored advertising to be updated and refreshed with additional advertisements.

These and other advantages of the present invention are achieved by a method for filtering and displaying multiple advertising based on content being displayed. The method receives multiple advertising at a client via a broadband medium and displays high-bandwidth content at the client. The multiple advertising includes a package of a plurality of advertisements and the high-bandwidth content is of a form chosen from a list consisting of: video, audio, text, and a combination thereof. The method also evaluates a correlation between each of the advertisements of the multiple advertising and the displayed high-bandwidth content and ranks each advertisement of the multiple advertising based on the correlation of each advertisement and the displayed high-bandwidth content.

These and other advantages of the present invention are also achieved by a computer readable medium and system that comprises a client that includes a memory containing instructions for performing the method for filtering and displaying multiple advertising based on content being displayed. The computer readable medium and the memory contain instructions for receiving multiple advertising at a client via a broadband medium and displaying high-bandwidth content at the client. The multiple advertising includes a package of a plurality of advertisements and the high-bandwidth content is of a form chosen from a list consisting of: video, audio, text, and a combination thereof. The computer readable medium and the memory also contain instructions for evaluating a correlation between each of the advertisements of the multiple advertising and the displayed high-bandwidth content and ranking each advertisement of the multiple advertising based on the correlation of each advertisement and the displayed high-bandwidth content.

These and other advantages are also achieved by a method of generating a user profile, wherein multiple items of content are selected by a user. The method receives a plurality of items of high-bandwidth content via a broadband medium, assigns a unique identifier for each of the items of high-bandwidth content, receives a user's selection of items of high-bandwidth content, increments a count for each unique identifier each time the corresponding item of content is selected by the user, sorts the counts for each unique identifier from a highest count to a lowest count, and stores the sorted counts.

These and other advantages are also achieved by a computer readable medium and a system comprising a client that includes a memory that contain instructions for performing the method of generating a user profile in the preceding paragraph.

These and other advantages are likewise achieved by a method of filtering and displaying multiple advertising based on a user profile. The method receives multiple advertising, that includes a package of a plurality of advertisements, at a client via a broadband medium, correlates the multiple advertising with a user profile, whereby each of the advertisements of the multiple advertising are correlated with the user profile, and ranks each advertisement based on the correlation of the advertisement with the user profile. The sorted advertisements are ranked from a highest ranking to a lowest ranking so that the advertisement with the highest correlation is placed at the highest ranking. The method also displays a subset of the advertisements of the multiple advertising. The subset is chosen based on the ranking of the advertisements, with high-bandwidth content.

These and other advantages are also achieved by a computer readable medium and a system comprising a client that includes a memory containing instructions for performing the method of filtering and displaying multiple advertising based on a user profile described in the preceding paragraph.

### BRIEF DESCRIPTION OF THE DRAWINGS

The detailed description will refer to the following drawings, in which like numbers and letters refer to like items, and in which:

FIG. 1 is a schematic diagram illustrating an exemplary content delivery system that may be used to deliver a branded channel.

FIGS. 2A and 2B are block diagrams illustrating exemplary hardware components that support and enable delivery of a branded channel.

FIG. 3 is a diagram illustrating an exemplary program nugget that includes information about an item of content.

FIG. 4 is a flowchart illustrating a method of filtering and displaying multiple advertising based on program classification of displayed content.

FIG. 5 is a diagram illustrating an exemplary user profile that may be used to filter multiple advertising.

FIGS. 6A, 6B and 6C are flowcharts illustrating exemplary methods of filtering and displaying multiple advertising with user profiles.

### DETAILED DESCRIPTION OF THE INVENTION

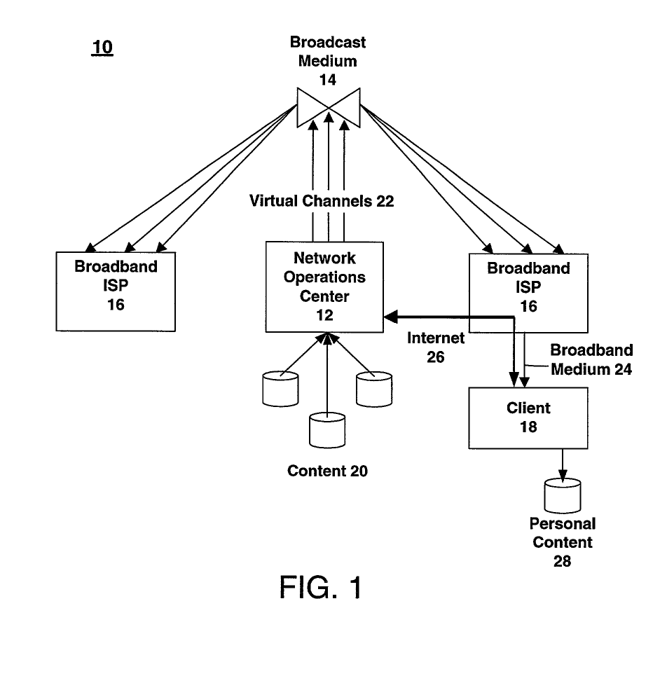

FIG. 1 illustrates a broadband content delivery system 10 with which the present invention may be used to deliver a multiple advertising. Multiple advertising preferably includes a package of a plurality of advertisements and is a type of content that may be delivered to users by the broadband content delivery system 10. The plurality of advertisements may be video, audio, or textual in form, or a combination thereof. Multiple advertising that may be filtered and displayed based on a user profile and/or other content currently being displayed. The multiple advertising may also be stored for later display and updated to remain current. The broadband content delivery system 10 is exemplary and the multiple advertising of the present invention may be delivered by any content delivery system and delivered in any manner. For example, content, including the multiple advertising, may be delivered through a file-based forward-and-store system. The illustrative broadband content delivery system 10 comprises a signal origination point 12, a transmission medium 14 (e.g., a satellite or a landline), one or more service providers 16, and one or more clients 18. The client 18 typically includes a user machine (e.g., a PC) that includes resident client software. The client software enables access to the broadband content, supports the broadband content delivery system 10 and delivery of the multiple advertising. The client 18 that receives multiple advertising may be resident in a user's home or at a store that sells products and services of or related to the multiple advertising.

Typically, high bandwidth content 20 (e.g., video, audio and web data) is transmitted from a signal origination point 12 such as a Network Operations Center (“NOC”) on high-resolution (“high rez”) virtual channels 22. The branded channels may be delivered as virtual channels 22. The NOC may include one or more servers that support the delivery the virtual channels 22, including the branded channels. The servers preferably multiplex or otherwise combine streams of content 20 onto one or more virtual channels 22. For example, the servers may multiplex streams of branded channel content, e.g., provided by the brand, onto a virtual channel 22 to create a branded channel. The transmission medium 14 is satellite, ether and/or landline, or a combination thereof. The content 20 is received by a service provider 16, typically an edge-of-net broadband Internet service provider (“ISP”) and transmitted over a broadband medium 24, such as a digital subscriber line (“DSL”) or coaxial cable, to a client 18. The broadband medium connection may be maintained or “open” continuously or substantially maintained continuously. Two-way communications between the client 18 and the NOC 12 are maintained over the Internet 26. Content may also be received by the client 18 directly from the Internet 26 via the ISP 16.

In addition to transmitting the content on virtual channels 22, the broadband content delivery system 10 also transmits a control channel (signal) that is received by the client 18. The control channel contains information and instructions that help enable the client 18 (i.e., the client software) to access and control the content 20 provided by the broadband content delivery system 10. The control channel is used to issue commands or directives to the client 18. These commands or directives may result in feedback or a report back from the client 18 to the NOC 12 via the Internet. Significantly, the control channel is used to deliver program descriptors or “program nuggets”, and digital messages.

Not necessarily all clients 18 of the broadband content delivery system 10 will have the bandwidth capability or resources to receive the high bandwidth on high rez virtual channels 22 (e.g., 512 Kbps or more). Accordingly, in addition to high bandwidth content 20, the broadband content delivery system 10 provides low bandwidth content 20 on low-resolution (“low rez”) virtual channels 22 (e.g., approximately 200 Kbps) or other communications bandwidth to accommodate these clients. Consequently, when a client 18 signs-on, the broadband content delivery system 10 preferably conducts a bandwidth test to measure client's 18 bandwidth capability (“available bandwidth”). Usually, the available bandwidth is calculated as the maximum bandwidth content that the client 18 can consistently receive.

Referring back to FIG. 1, content 20, including multiple advertising, may be transmitted, delivered or broadcast (broadcast, delivered, and transmitted is meant herein to include any method of delivering content, including for example, multicasting, unicasting, direct transmission, or file download) by the NOC 12 on the virtual channels 22 as real-time multicast or unicast streams. A multicast stream comprises streaming content that is directed to and available to multiple clients 18 that join a multicast group. A unicast stream comprises streaming content that is directed to and available to one client 18 at a time; unicast content must be replicated for each client 18 that receives it. Furthermore, additional content 20 may be provided by third-parties as on-demand broadband content selected from the Internet (“edge-of-net”) by a user at the client 18. For example, an ISP 16 may provide the edge-of-net content. Likewise, the user may store selected content, such as portions of the real-time multicast or unicast streams in a local cache at the client 18. This stored or personal content 28 may be kept on a user machine hard-drive or other storage medium.

A company that wants to provide a multiple advertising may deliver content related to the company's brand to the NOC 12 (or other content delivery origination point) for delivery to clients 18. The company may transmit the multiple advertising content via a communication medium to the NOC 12 for preparation and placement on the branded channel. Alternatively, a third-party may prepare the content for the multiple advertising at the company's request or direction. Likewise, the company may maintain its own NOC and itself deliver the multiple advertising content directly to clients 18, via the Internet, forwarding and storing of content, or other content delivery mechanisms. When displayed by the client 18, the multiple advertising may be shown with a web browser (see below).

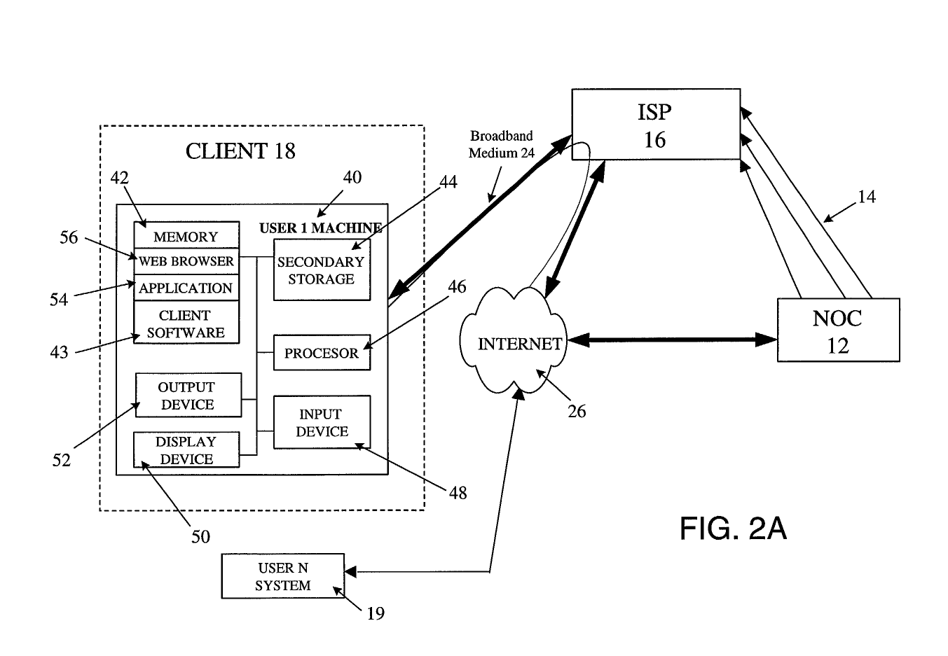

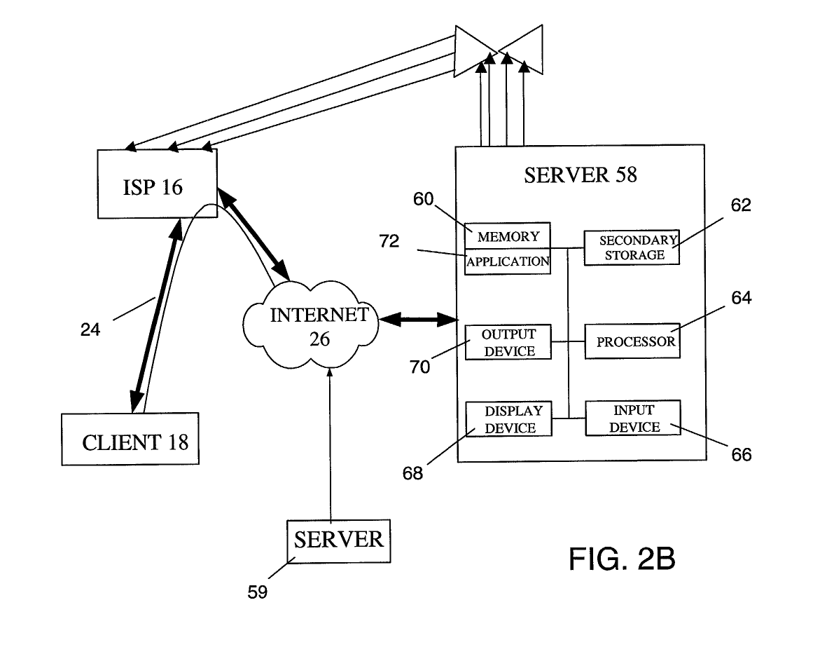

FIGS. 2A and 2B are block diagrams illustrating exemplary hardware components of the exemplary broadband content delivery system 10, or other content delivery system, that may be used for implementing and delivering the multiple advertising. FIG. 2A includes the client 18, comprising a user machine 40 connected with a network such as the Internet 26, providing network connections to the NOC 12 and the ISP 16 (or other content source). As noted above, the client 18 may be resident in a user's home or at a store that sells products and services of or related to the brand of the branded channel. The user machine 40 includes the client software 43 that the user has downloaded from an ISP 16 or portal or otherwise obtained (e.g., by loading from a CD-ROM or magnetic disk or by being pre-installed on the user machine 40). As mentioned, the client software 43 supports the broadband content delivery system 10 and is preferably executed to perform some or all of the multiple advertising methods described herein. Other clients 18, such as client 19 may also be connected with network and may include the same components as client 18.

The user machine 40 illustrates typical components of a user machine. The user machine 40 typically includes a memory 42, a secondary storage device 44, a processor 46, an input device 48, a display device 50, and an output device 52. Memory 42 may include random access memory (RAM) or similar types of memory, and it may store one or more applications 44, including client software 43, and a web browser 56, for execution by processor 46. The secondary storage device 44 may include a hard disk drive, floppy disk drive, CD-ROM drive, or other types of non-volatile data storage. The local cache that includes a user's personal content 28, may be stored on the secondary storage device 44.

The processor 46 may execute client software 43 and other applications 44 stored in memory 42 or secondary storage 44, or received from the Internet or other network 26. As mentioned above, the processor 46 may execute client software 43 in order to provide some or all of the functions described in this specification. The input device 48 may include any device for entering information into the user machine 40, such as a keyboard, mouse, cursor-control device, touch-screen, infrared sensor, microphone, digital camera, video recorder or camcorder. The display device 50 may include any type of device for presenting visual information such as, for example, a computer monitor or flat-screen display. The output device 52 may include any type of device for presenting a hard copy of information, such as a printer, and other types of output devices include speakers or any device for providing information in audio form.

The web browser 56 is used to access the client software 43 and display interface screens through which the user can view content, including the branded channel, delivered by the broadband content delivery system 10 or otherwise obtained from any content source. The web browser 56 also is used to access the NOC 12, the ISP 16, and third-party websites that include other content (e.g., digital music and video files). Examples of web browsers 56 include the Netscape Navigator program and the Microsoft Internet Explorer program. The content broadcast on virtual channels and received by the client 18 may be displayed through the web-browser 56. The content may include “links”, for example, HyperText Transport Protocol (“HTTP”) hyperlinks to other content and/or Internet websites. Multimedia applications such as Microsoft Media Player™ and RealPlayer™ may be used to enable viewing of the real-time multicast stream. Any web browser, co-browser, or other application capable of retrieving content from a network (any wireline or wireless network may be used) and displaying pages or screens may be used.

Examples of user machines 40 for interacting within the broadband content delivery system 10 include personal computers, laptop computers, notebook computers, palm top computers, network computers, Internet appliances, Internet kiosks, or any processor-controlled device capable of executing a web browser 56 or other type of application for interacting with the broadband content delivery system 10 or other content source. The user machines may also be kiosks or interactive kiosks that are typically presented in a retail environment. For example, an interactive kiosk that displays content provided by the branded channel can be presented in an aisle of a store that sells products or services of corresponding brand. Such an interactive kiosk may display content regarding the brand's products or services offered in the aisle in which the kiosk is located, providing moment-in-time marketing and allowing store customers to learn more about the brand's products or services. For example, a convenience store may have a kiosk that displays branded channels for such brands a Coke®, Frito-Lay® or any other brand of products that the convenience store sells. Likewise, a store may have its own branded channel that includes content about the products and services sold under the store's brand or other brands. The store may also display its branded channel on interactive kiosks and may offer available advertising times (“avails”) on the branded channels displayed on the kiosks to companies whose products or services are sold by the store.

The NOC 12, or other content source, may comprise one or more servers. FIG. 2B illustrates typical hardware components of a NOC or content source server 58. The branded channel may be implemented and delivered with one NOC or content source server 58 or with a NOC or content source servers 58. Other servers at the NOC 12, at the ISP 16, or other content source, may have similar or the same hardware components. The server 58 typically includes a memory 60, a secondary storage device 62, a processor 64, an input device 66, a display device 68, and an output device 70. The memory 60 may include RAM or similar types of memory, and it may store one or more applications 72 for execution by processor 64. The applications 72 may perform the methods (or portions thereof) described below.

The secondary storage device 62 may include a hard disk drive, floppy disk drive, CD-ROM drive, or other types of non-volatile data storage. The processor 64 executes applications 72, that are stored in memory 60 or secondary storage 62, or received from the Internet 26 or other network. The input device 66 may include any device for entering information into server 58, such as a keyboard, mouse, cursor-control device, touch-screen, infrared sensor, microphone, digital camera, video recorder or camcorder. The display device 68 may include any type of device for presenting visual information such as, for example, a computer monitor or flat-screen display. The output device 70 may include any type of device for presenting a hard copy of information, such as a printer, and other types of output devices include speakers or any device for providing information in audio form.

The server 58 may store a database structure in secondary storage 62, for example, for storing and maintaining information regarding the broadband content delivery system 10, the clients 18, and/or the branded channels. For example, it may maintain a relational or object-oriented database, or any other type of database, for storing information concerning users, the access rights of the users and their account status. Likewise, it may maintain a relational or object-oriented database, or any other type of database, for storing information concerning links between and among content provided on the branded channel and other content broadcast by the system.

As mentioned above, processor 46 and/or processor 64 may execute one or more software applications 44 or 72 in order to deliver and support the branded channel, methods, and other functions described in this specification. The processing may be implemented in software, such as software modules, for execution by computers or other machines.

The processing by processor 46 and/or processor 64 may provide and support pages, windows and menus (collectively, “screens”) described in this specification and otherwise for display on display devices associated with the client 18. The term “screen” refers to any visual element or combinations of visual elements for displaying information or forms; examples include, but are not limited to, graphical user interfaces on a display device or information displayed in web pages or in pop-up windows/menus on a display device. The screens may be formatted, for example, as web pages in HyperText Markup Language (HTML), Extensible Markup Language (XML) or in any other suitable form for presentation on a display device depending upon applications used by users to interact with the broadband content delivery system 10 or other content source.

Although only one server 58 is shown, broadband content delivery system 10 or other content source may use multiple servers 59 as necessary or desired to support the users and may also use back-up or redundant servers to prevent network downtime in the event of a failure of a particular server. In addition, although the user machine 40 and server 58 are depicted with various components, one skilled in the art will appreciate that the user machine 40 and the server 58 can contain additional or different components. In addition, although aspects of an implementation consistent with the present invention are described as being stored in memory, one skilled in the art will appreciate that these aspects, components or applications can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling a computer system, such as user machine 40 and server 58, to perform a particular method or implementation, such as those described below.

Multiple advertising may be provided to clients 18 by the broadband content delivery system 10 or other broadband communication mediums. Multiple advertising may be delivered as a continuous stream or in discrete increments. Program nuggets 74 or headers corresponding to and describing each advertisement in the multiple advertising may be delivered prior to or during the delivery of the multiple advertising. The multiple advertising, program nuggets 74, and/or other content items may be delivered to the client 18 as a packaged file in a file-based forward-and-store system.

As discussed above, the multiple advertising may be filtered and displayed based on the content being currently displayed by a client 18. Typically each item of content that is delivered (e.g., as a real-time stream on a virtual channel) has a corresponding program nugget 74. In the broadband deliver system 10, as discussed above, program nuggets 74 are preferably delivered on the control channel. The program nugget 74 may be transmitted by the NOC at some time preceding the delivery of the corresponding content. Alternatively, the program nugget 74 may be delivered with the corresponding content (and with the multiple advertising) in a packaged file. The program nugget 74 may be included in a content header (e.g., a header of a stream of packets that comprise an item of content). Program nuggets 74 may also be transmitted by the NOC for edge-of-net content.

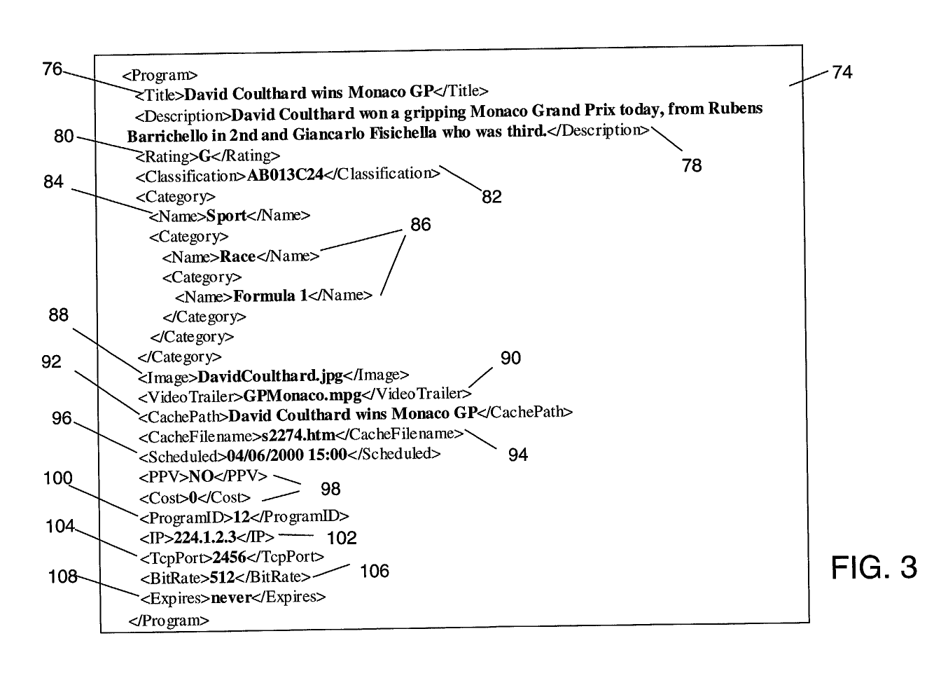

With reference now to FIG. 3, an example of a program nugget 74 is shown. The program nugget 74 shown includes various information and data related to the corresponding content item. For example, this information and data may comprise a program title 76, a program description 78, a rating 80, a program classification 82, a program category name 84, program sub-category names 86, a thumbnail display 88 or link to thumbnail display, a link 90 to a video trailer, a local cache path 92, a local cache filename 94, schedule information 96, pay-per-view information 98, a program ID 100, a source IP address 102, a source TCP Port 104, a bitrate 106 and an expiry date 108 for the program. As seen from FIG. 3, other data and information may be included in the program nugget 74.

The program nugget 74 is usually written in Extensible Markup Language (“XML”) format, although other formats may be used. If the program nugget 74 is written in XML, the information and data from the program nugget 74 may be easily used to generate or incorporated in a dynamic hyper-text markup language (“DHTML”) page. Typically, the program nugget 74 is stored at the client 18 on the secondary storage device 44 (e.g., hard-drive or other storage medium). Program nuggets 74 will usually remain stored at the client 18 at least until the corresponding content is viewed. Consequently, program nuggets 74 corresponding to personal content that the user has saved in the local cache will be available when the user chooses to examine or view the personal content. Alternatively, program nuggets 74 can be re-transmitted or requested at a later time.

With continuing reference to FIG. 3, the program classification 82 may provide the type of content (e.g., professional baseball game, horror movie, rock music, historical documentary, etcetera) and the general category of the content item. For example, a number may indicate the program classification 82. Specific ranges of numbers may indicate a general category (e.g., 1400-1499 may indicate sports programs). A sub-range of numbers within the general category range may indicate a sub-category (e.g., 1400-1405 may indicate baseball programs). Likewise, a specific number may indicate a specific type of content (e.g. 1401 may be professional baseball games). Program classification 82 may also be indicated by other classifications systems, such as binary numbers (e.g., 16 bits, in which the first four bits indicate general category, the second four bits indicate sub-category, the third four bits indicate sub-sub-category and the last four bits indicate program type), combinations of letters, letters and numbers or any similar system. The program classification 82 is preferably used when the content currently being displayed is used to filter or determine which advertising to display.

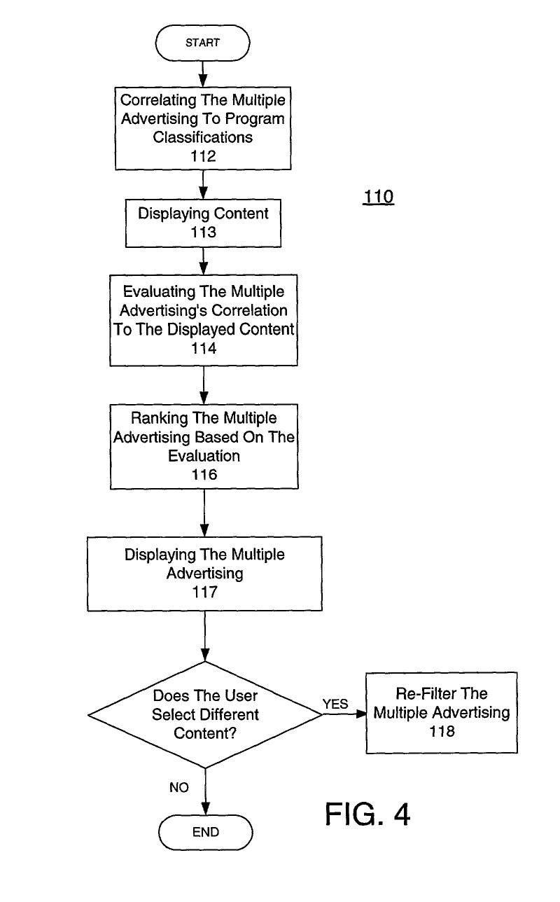

With reference now to FIG. 4, a flowchart illustrating an exemplary method 110 of filtering and displaying multiple advertising based on a program classification 82 of displayed content is shown. Multiple advertising provides numerous advertising options to clients 18. Therefore, filtering methods are helpful for presenting appropriate ads to users. As seen in FIG. 4, the method 110 comprises the steps of: correlating the multiple advertising to program classifications 112, displaying content 113, evaluating the multiple advertising's correlation to the displayed content 114, ranking the multiple advertising based on the evaluation 116, and displaying the multiple advertising 117. The correlating step 112 preferably comprises determining what type(s), sub-category(ies) and/or general category(ies) of content each advertisement best fits or matches and indicating these best fits or matches. For example, an advertisement for golf clubs may best fit with a golf tournament broadcast, golf programs and sports programs in general. Marketing professionals or experts may perform the correlating step 112 at any location. The correlating step 112 may be performed for each advertisement on an individual basis by or for the owner of the advertisement. Alternatively, the correlating step 112 may be performed by a programmed algorithm designed to best match advertising to content.

A correlation number or correlation numbers, assigned to each advertisement by the correlating step 112, is preferably used to indicate the best match. Generally, the correlation number indicates with which type of content the advertisement best fits. The correlation number(s) is preferably the program classification 82 for the type or types of content that the advertisement best fits. The correlation number(s) may be stored in each advertisement's program nugget 74 or in each advertisement's header. As stated above, the advertisements' program nugget 74 or headers may be delivered prior to or during the delivery of the multiple advertising. The displaying step 113 preferably displays content on the display device 50 of the client 18 (e.g., in a web browser 56 window).

With continuing reference to FIG. 4, the evaluating step 114 preferably comprises the client 18 (e.g., the client software 43) determining the displayed content's program classification 82 and comparing each advertisement correlation to the displayed content's program classification 82. For example, the evaluating step 114 may comprise determining the displayed content's classification from the displayed content's program nugget 74 and comparing each advertisement's correlation number(s) to the content's program classification 82.

The evaluating step 114 may further comprise assigning a score to each advertisement based on the comparison. The score preferably is a number that indicates how well an advertisement correlates with a particular item of displayed content. If the advertisement's correlation number is a program classification that exactly matches the program classification of the displayed content, the evaluating step assigns the advertisement a highest score. The score, therefore, is preferably based on an evaluation using the correlation number, which indicates the type or types of content with which the content best fits. For example, an advertisement will receive a highest score if there is an exact match between an advertisement's correlation number and the displayed content's program classification 82 (e.g., the advertisement for golf clubs for display during the display of a golf tournament), a second highest score if the correlation number is in the same sub-category as the program classification 82, but not an exact match (i.e., different program type indicated by numbers), a third highest score if the correlation number is in the same general category as the program classification 82, and so on. An advertisement may have multiple correlation numbers, when it is determined that the advertisements match multiple types of programs equally or nearly equally well (e.g., a beer advertisement that matches numerous types of sports programs extremely well). Advertisements with multiple correlation numbers, therefore, will have a greater chance of a receiving a highest score.

With continuing reference to FIG. 4, the ranking step 116 preferably comprises placing the advertisements in order, based on their scores, from highest score to lowest score. Ranking is defined herein generally as ranking, sorting, organizing, compiling and/or ordering the advertisements. The displaying multiple advertising step 117 preferably comprises the client 18 displaying a subset of the multiple advertisements based on the advertisements rankings. The subset is preferably a certain number (e.g., one, two, five, ten, fifteen, etc.) of the top-ranked advertisements. The number of top-ranked advertisements displayed is preferably determined by the length of the content, the length of the advertisements (if the advertisements have a length—the advertisements may be a constant or steady message), time purchased by the advertisers and/or other factors, such as whether the top advertisements are being rotated or only shown once. The displaying step 117 may display the advertisements as banner ads in the browser window in which the content is displayed, in a separate window, or in breaks in the content, similar to television advertising. If a user changes the content being displayed, the client 18 (e.g., the client software 43) may re-filter (step 118 in FIG. 4) the multiple advertising as appropriate for the new content (i.e., by repeating steps 114 and 116). If the new content is a different program type, the re-filtering 118 may produce different results. The client 18 may wait a certain period of time (e.g., thirty-seconds) before re-filtering the advertisements.

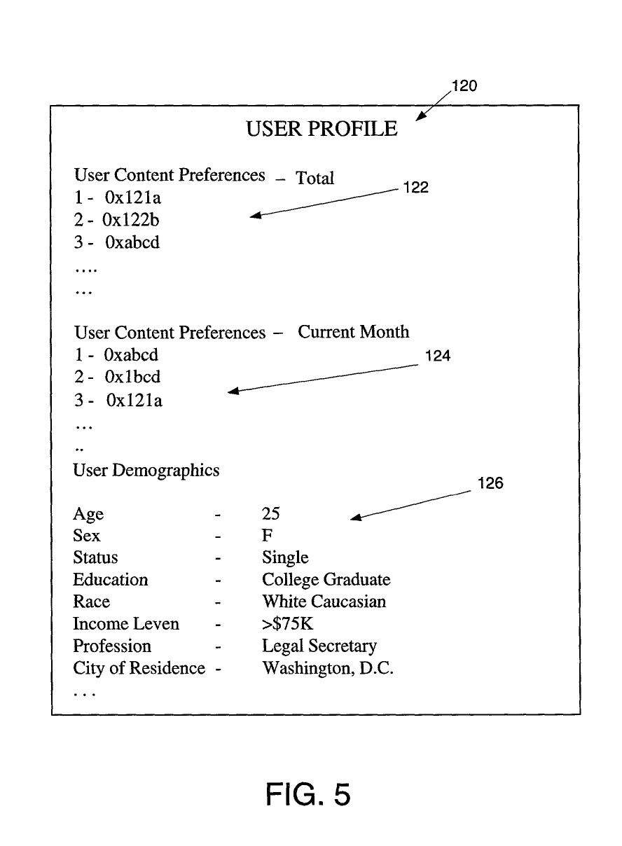

With reference now to FIG. 5, an exemplary user profile 120 is shown. The multiple advertising may be filtered and displayed based on the user profile 120 of the user viewing content at the client 18. A user's preferences and interests may be determined according to an analysis of historical content viewing and usage accrued in a user profile 120 (also known as a “personal profile”). The broadband content delivery system 10 and/or the client 18 preferably track the user's viewing decisions or habits in order to create the user profile 120. Alternatively, other delivery systems used may create the user profile 120. For example, the program classification 82 for each program that the user views may be recorded, thereby creating a running total 122 of the number of programs of each program type (indicated by the program classification 82) that the user views. Accordingly, the user profile 120 preferably comprises the user's content preferences as determined by this running yearly total 122, monthly total 124, daily total (not shown), or all-time total (not shown). For example, if the running yearly total 122 indicates that the user has viewed professional hockey games 85 times out of 100 total content items viewed, the user profile 120 will include a first program type preference for professional hockey games. In the same example, the user profile 120 may also include a first sub-category preference of hockey and a first general category preference of sports. The data comprising the running total and user preferences, as well as the user profile 120 generated from this data, may be stored on the secondary storage device 44 (e.g., hard-drive) of the client 18.

A description of an exemplary algorithm for using program classifications to generate a user profile 120 and using the user profile 120 to filter the multiple advertising (or any other content) follows. In this example, the program classification 82 is arranged in multiple levels, for example: content form, such as video, audio or data, at the highest level; general category, such as music, news, educational, movie, television program, information, etc., at the next level; sub-category, such as rock, country, classical, national, international, math, science, history, drama, sci-fi, mystery, etc., at the next level; and specific type, such as Metallica, REM, Garth Brooks or Beethoven concert, ABC, CBS or NBC Nightly News, Calculus, Trigonometry or Geometry lesson, etc., at the lowest level. The program classification 82 may also include other sub-levels of classification between and after the above-described levels. The program classification 82 may look like a directory (tree) structure of a file system.

A unique identifier may represent the program classification 82 for each piece of content. The NOC 12 or client 18 preferably track the daily (or hourly, weekly, monthly, quarterly, yearly, etc.) usage of a particular program classification 82 by assigning a usage summary for each day's (or hour's, week's, month's, quarter's, year's, etc.) history. Using each day's history, the NOC 12 or client 18 preferably determine users' preferences by sorting the count value for each unique identifier.

As an example, with “id” as the unique identifier, a bitmask is used to represent id. Using a bitmask makes id easy to track. If, for example, a content's program classification 82 is content form=audio→category=music→sub-category=rock→type=REM, then using a 16 bit word (assuming a small number for categories) we can represent id for that content as, for example:

0001 0010 0001 1001=0×121a,

where the least significant digit (“a”) represents the type=REM, the second least significant digit (“1”) represents sub-category=rock, the third least significant digit (“2”) represents category=music, and the forth least significant digit (“1”) represents form=audio.

For each unique identifier, each day is a byte of data. Accordingly, there may be up to thirty-one (31) bytes (8-bit) of data for each monthly history (i.e., 31 bytes for a 31-day month, 30 bytes for a 30-day month, 28 or 29 bytes for February). Consequently, there are twelve (12) 8-bit words used to maintain yearly history by month. To maintain the viewing history for the audio→music→rock→REM content, each time a user selects (a “click”) the REM content (preferably limited to selections for a minimum amount of display time, e.g., five-minutes) represented by id=0×121a, the byte of data for id=0×121a, indexed by the date (e.g., if the day is index) of the month on which the REM content is selected, is incremented (e.g., by the client 18) by one. For each selection,

// check for a new day, zero the counter upon a new day (set by clock)
if [day = today] then

yesterday = today
today = day
// subtract value on date for last month
// if user stop clicking this could go to 0
word[month − 1] −= byte[day − 1];
byte[day−1] = 0
// monthly data
// check for a new month as well zero out if beginning of month

endif

| | |
|---|---|
| byte[day−1] = byte[day−1] + 1 | // for each content selection byte[0] |

word[month−1] = byte[0] + ... + byte[day−1] // update monthly data.

The user profile 120 includes sorted content preference lists (e.g., total 122 and monthly 124) of content types, sorted by count values from greatest to smallest in order to indicate the rankings of user content preference. If the count values for content types in a user profile 120 are already sorted then resorting after each content selection is straightforward. The current monthly count 124 and daily count (not shown) in a user profile 120 are preferably only sorted with adjacent counters and moved if needed. Very little performance (CPU) is required to perform this sorting.

To match content preference data in a user profile 120 with incoming content (e.g., multiple advertising), the ids of the incoming content are matched to the ids of the content types in the sorted user preference list (122 or 124). When there is a match, depending on where the match is in the list, the user's preference for the incoming content can be determined with that particular id. By maintaining up to 31-days of data and 12-months of data, the NOC 12 or client 18 can determine preferences for content on a daily or monthly basis. The NOC 12 or client 18 preferably do this by keeping a list for days (as bytes) and a list for months (word), which for the current month sums up the days in the month to the current day. The NOC 12 or client 18 preferably also keep a list of the sums of the months for a yearly total as well (e.g., a 32-bit long word).

An example of a sorted daily list assuming structure (with a count and an id):

day_list_today[0].count=highestcount //based on today (one list for each day).

day_list_today[0].id=0×121a //identification, not used for sorting

day_list_today[1].count=next highestcount

day_list_today[1].id another id

. . .

Also, a similar monthly list:

mon_list_current[0].count=highestcount

mon_list_current[0].id=0×abcd

mon_list_current[1].count=next highestcount

mon_list_current[1].id=0×121a

. . .

As shown, the daily and monthly 124 user content preference lists preferably include two entries for each content type: the user's viewing count for the content type and the id for the content type. As seen, the REM content (id 0×121a) was selected the most for today (i.e., the REM content had the highest count) but not for the month. Rather, the REM content was the next highest count for the monthly list of user preferences.

To filter the multiple advertising with the user's preferences, each advertisement is assigned one or more ids that correspond to the type(s) of content (e.g., programs) that the advertisements best fit or match. These ids of the advertising may be matched to the ids at the top of the user content preference lists. The determination and assignment of ids to advertisements may be done by marketing professionals or experts. Marketing professionals or experts may perform this assignment of ids at any location. The assignment may be performed for each advertisement on an individual basis by or for the owner of the advertisement. Alternatively, the assignment may be performed by a programmed algorithm designed to best match advertising to content. The matching of advertisement ids to user content preference ids are preferably done based on daily lists, monthly lists, yearly lists or a combination thereof. For example, the NOC 12 or client 18 may look at a user's monthly content preference list first and then the daily list to distinguish between advertisements that had similar fits under the monthly lists.

If the ids of the advertisements do not match exactly to the ids in the content preference list, the NOC 12 or client 18 may also look at the bitmasks of the ids to compare the next higher level of program classification for an upper level match. For example, an id=0×121c does not exactly match id=0×121a. However, these two ids do match up to the sub-category classification of rock music (i.e., 0×121* and 0×121*). Accordingly, an advertisement with the id=0×121c will have an upper level match at the sub-category level with content with the id=0×121a. In an exemplary algorithm, the NOC 12 or client 18 may rank the best thirty (30) advertisements. However, if there were less than thirty exact id matches, the NOC 12 or client 18 may go up to the next higher level of program classification and attempt to match ids at the sub-category level (or higher). The content preference lists are preferably re-organized to provide counts by the next higher program classification level (i.e., counts for id=0×121a and id=0×121c would be added together for a count for id=0×121*, where * is a wild card) and then the ids are compared. In this algorithm, the NOC 12 or client 18 preferably repeat this step and move up to the next higher program classification level until thirty (30) matches are found.

In the above example, user selection (clicks) are used to increment counts of content types in order to track user preferences. Alternatively, the time spent viewing content of a particular program classification 82 may be used as a criteria for tracking user preferences, rather then clicks. In this alternative, the preference data is preferably maintained similar to the algorithm above for clicks but instead of incrementing and decrementing clicks the operation would be done on time spent viewing content in a program classification category between clicks. A further alternative uses a combination of both methods for maintaining user preference data.

Note that the size of the data used is exemplary. The data needed to maintain clicks or time spent viewing content may have to be larger then a value of 255. In such a situation, a 16-bit word (or larger) is used.

Alternatively, the user may proactively create and/or modify the user's user profile 120. The user may select program type preferences from a list of program types. Likewise, the user may select sub-category and general category preferences from lists of sub-categories and general categories. Further, the user may modify the user's user profile 120 by re-ordering its existing content preference lists. For example, if the user's first program type preference is professional baseball games and the user wants to change this first program type preference to professional football games (e.g., because it is football season), the user may select professional football games from the list of program types. Any changes to the user's user profile 120 made by a user may also be stored in the secondary storage device 44 (e.g., hard-drive) of the client 18.

With continuing reference to FIG. 5, it is seen that the user profile 120 may also include demographic 126 and other similar information about the user. Such demographic information 126 may include age, sex, race, income level and, address, for example. The demographic information 126 may be entered when the user installs the client software 43 on the user machine 40. If the user machine 40 broadband connection is open when the client software 43 is installed, the user may register with a client services server (not shown—see the Digital Rights Management application referred to above), creating a user profile 120 containing the demographic information 126. The user may be prompted with a screen (not shown) containing data fields and displayed by the web browser 56 to enter this information during the registration process. When the multiple advertising is filtered and displayed based on a user profile 120, all or a subset of the data and information contained within the user profile 120 may be used. For example, the multiple advertising may be filtered and displayed merely based on the content preferences or the demographic information 126, or a combination thereof.

If the multiple advertising is filtered by the demographic information 126, each advertisement is preferably assigned a demographic identifier that is used to match the advertisements with the demographics of the user. For example, an advertisement may have a demographic identifier=female, single, 20-30, <$50k that specifies the advertisement is targeted to single females between 20-30 years old that earn $50k or more. If the user profile 120 includes demographic information 126 that fit one or more of these categories, the advertisement is ranked and sorted accordingly.

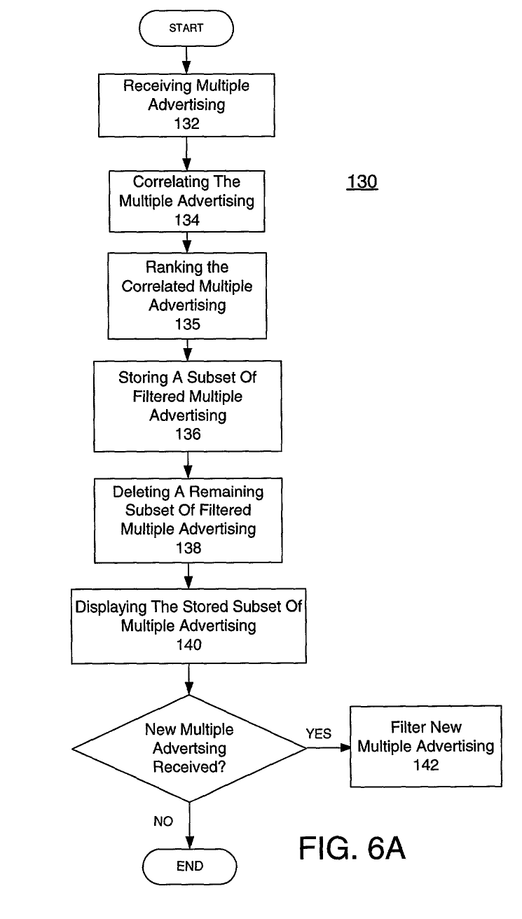

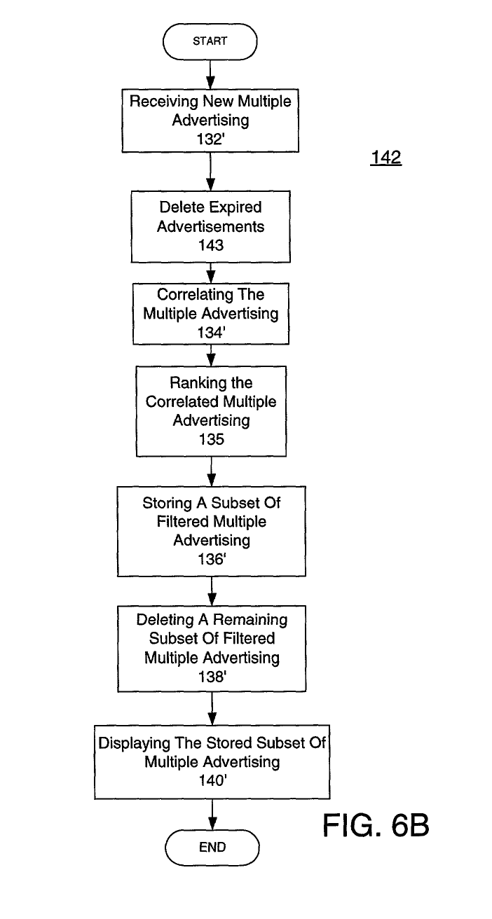

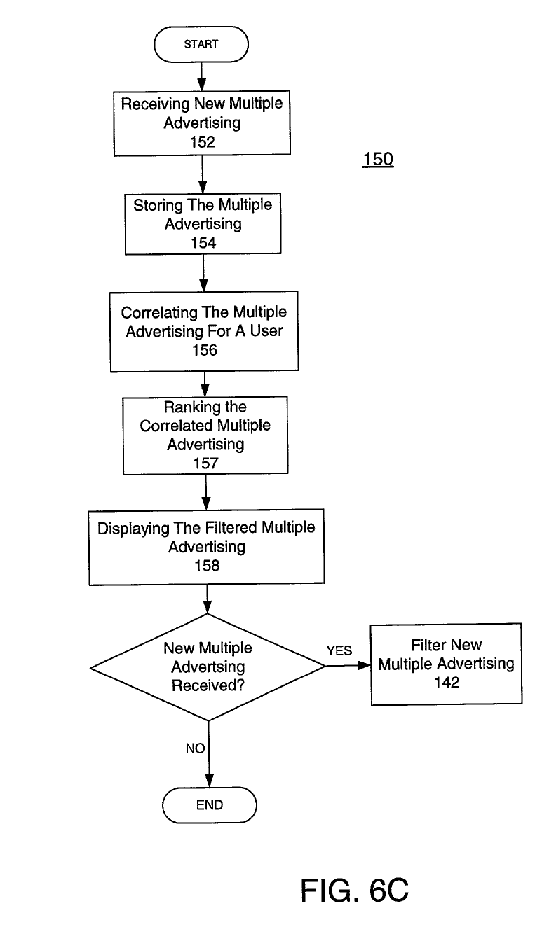

With reference now to FIG. 6A, a flowchart illustrating a method 130 of filtering and displaying multiple advertising based on a user profile is shown. As shown in FIG. 6A, the method 130 preferably comprises the steps of: receiving multiple advertising 132, correlating the multiple advertising, whereby a plurality of advertisements are correlated with a user profile 134, ranking the correlated multiple advertising 135, storing a subset of filtered multiple advertising 136, deleting a remaining subset of filtered multiple advertising 138, and displaying the stored subset of multiple advertising 140. The receiving step 132 preferably includes client 18 receiving a large group of advertisements (e.g., 100 advertisements). These advertisements may have been transmitted by the NOC 12 on a virtual channel or in a file (e.g., packaged with program nuggets 74 and with other content).

In the method illustrated by FIG. 6A, the multiple advertisements are preferably immediately filtered by the client 18 upon receipt based on the user profile 120. The correlating step 134 is preferably performed according to the exemplary methods described above, or other methods. For example, the correlating step 134 preferably correlates each advertisement of the multiple advertising to the user profile and assigns a score to each advertisement based on the advertisement's correlation with the user profile 120 (e.g., correlation to the content preferences and/or demographic data in the user profile 12). The ranking step 135 preferably then ranks or sorts the advertisements, based on the advertisements' scores, in a descending order from the highest scoring advertisement to the lowest scoring advertisement.

As shown in FIG. 6A, the method 130 preferably comprises storing a subset of the multiple advertisements 136 and deleting the remaining advertisements 138. The storing step 136 preferably stores a subset including a certain number of the top ranked advertisements (e.g., top 50 advertisements) in the secondary storage device 44 of the client 18. The deleting step 138 preferably deletes the advertisements that are ranked to low to be worthwhile storing.

As with the displaying step 117 in FIG. 4, the displaying step 140 preferably displays the top ranked advertisements in conjunction with other displayed content. For example, the advertisements may be displayed as banner ads surrounding a screen that is displaying the content (e.g., a browser window) or as separate pop-up ads that appear separate from the screen displaying the content. Alternatively, the advertisements may be displayed during breaks or interruptions in the content, similar to regular television advertising. The client 18 may determine the display of advertisements by cycling through the advertisements based on the advertisements' score. For example, the displaying step may display the highest scoring advertisements first, most prominently and for the longest period of time.

Since the method 130 stores a subset of the multiple advertising, the stored advertisements may be displayed with content displayed when the multiple advertising is received or with later received content. Furthermore, the stored subset of multiple advertising may be updated and refreshed with later received multiple advertising. For example, the method 130 may include a step (method) 142 of filtering new multiple advertising, which repeats the steps of the method 130, as illustrated by the flowchart in FIG. 6B. As shown in FIG. 6B, the method 142, therefore, preferably receives 132′ new multiple advertising, correlates 134′ and ranks 135′ the new multiple advertising with the stored subset of multiple advertising, stores 136′ a new subset of multiple advertising, deletes 138′ the remaining multiple advertising, and displays the stored multiple advertising 140′. The correlating step 134′ preferably takes into consideration the age of the stored advertising, reducing the score of an advertisement if the advertisement is beyond a certain age (e.g., more than two (2) weeks old). Alternatively, the advertisements may be assigned an expiration date and the repeating method 142 may include the step of deleting expired advertisements 143.

With reference now to FIG. 6C, a flowchart illustrating an alternative method 150 for filtering and displaying multiple advertising is shown. The method 150 comprises the steps of: receiving multiple advertising 152, storing the multiple advertising 154, correlating the multiple advertising for a user 156, ranking the correlated multiple advertising 157, and displaying the correlated and ranked multiple advertising 158. In certain situations, the advertisements may not be stored and/or deleted based on the initial filtering. For example, if a client 18 has multiple users, all of the advertisements are preferably stored on the client 18 so that the multiple advertising may be filtered for each user. In such a situation, the advertisements may be filtered based on the user profile 120 of the user currently viewing content so as to determine what subset of advertisements to display to that user in conjunction with the content. All of the advertisements may be stored at the client (e.g., on the secondary storage device 44) for later filtering based on the user profile(s) of the other user(s). Alternatively, the advertisements may be filtered based on the user profiles of each user and the top advertisements for each user stored in a folder or directory specific to that user. The stored multiple advertising may be updated or refreshed as described with reference to FIG. 6B.

Furthermore, if the multiple advertising is filtered based on the user profile 120, the multiple advertising may also be re-filtered based on the content being displayed. This filtering may be done, for example, according to the method illustrated by FIG. 4. In this manner, the multiple advertising is filtered both by the user profile and the content being displayed.

While the invention has been described with reference to the exemplary embodiments thereof, those skilled in the art will be able to make various modifications to the described embodiments of the invention without departing from the true spirit and scope of the invention. The terms and descriptions used herein are set forth by way of illustration only and are not meant as limitations. Those skilled in the art will recognize that these and other variations are possible within the spirit and scope of the invention as defined in the following claims and their equivalents.

What is claimed is:

1. A method for filtering and displaying multiple advertising based on content being displayed, comprising:
(a) receiving multiple advertising at a client via a broadband medium, wherein the multiple advertising includes a package of a plurality of advertisements;
(b) displaying high-bandwidth content at the client, wherein the high-bandwidth content is of a form chosen from a list consisting of: video, audio, text, and a combination thereof;
(c) evaluating a correlation between each of the advertisements of the multiple advertising and the displayed high-bandwidth content; and
(d) ranking each advertisement of the multiple advertising based on the correlation of each advertisement and the displayed high-bandwidth content.

2. The method of claim 1, further comprising the step of:
(e) displaying a subset of the advertisements of the multiple advertising based on the ranking of each advertisement.

3. The method of claim 2, wherein step (e) displays the subset of advertisements as banner ads on a window on a display device of the client.

4. The method of claim 2, wherein:
step (b) displays the high-bandwidth content in a first window on a display device of the client; and
step (e) displays the subset of advertisements in a second window on the display device.

5. The method of claim 2, wherein the high-bandwidth content has commercial breaks and step (e) displays the subset of advertisements during the commercial breaks.

6. The method of claim 2, wherein step (e) displays the subset of advertisements on a rotational basis, periodically displaying a different advertisement.

7. The method of claim 1, further comprising the step of:
correlating the multiple advertising to program classifications, wherein each high-bandwidth content item has a program classification that describes the high-bandwidth content item and whereby each of the advertisements of the multiple advertising is correlated to one or more program classifications.

8. The method of claim 7, wherein the displayed high-bandwidth content has a program classification and step (c) evaluates the correlation between each of the advertisements of the multiple advertising and the displayed high-bandwidth content based on the correlation of the multiple advertising to program classifications and the program classification of the high-bandwidth content.

9. The method of claim 8, wherein step (d) ranks an advertisement of the multiple advertising if the advertisement is correlated to a program classification that matches the program classification of the displayed high-bandwidth content.

10. The method of claim 7, wherein:
the program classifications comprise general categories, sub-categories and program types of high-bandwidth content; and
the correlating step determines what program type(s), sub-category(ies) or general category(ies) of high-bandwidth content that each advertisement of the multiple advertising best matches and indicates the best matches by assigning a correlation number to each advertisement.

11. The method of claim 1, wherein step (c) assigns a score to each advertisement that indicates how well each advertisement correlates with the displayed high-bandwidth content.

12. The method of claim 11, wherein step (d) sorts each advertisement based on the score assigned to each advertisement by step (c).

13. The method of claim 1, wherein step (d) generates a ranked list of at least five (5) advertisements that best correlate with the displayed high-bandwidth content and the method further comprises the step of:
displaying the five (5) advertisements from the ranked list.

14. A computer readable medium containing instructions for performing the method of claim 1.

15. A system for delivering multiple advertising, comprising:
a network operation center that transmits high-bandwidth content and multiple advertising;
a broadband medium, connected to the network operation center, over which the high-bandwidth content and the multiple advertising are transmitted; and
a client, connected to the broadband medium, that receives the high-bandwidth content and the multiple advertising, wherein the client comprises:
a memory that stores instructions for performing the method of claim 1; and
a processor that executes the instructions stored on the memory.

16. A method of generating a user profile, wherein multiple items of content are selected by a user, comprising the steps of:
receiving a plurality of items of high-bandwidth content via a broadband medium;
assigning a unique identifier for each of the items of high-bandwidth content;
receiving a user's selection of items of high-bandwidth content;
modifying a count for each unique identifier each time the corresponding item of content is selected by the user;
sorting the counts for each unique identifier based upon criteria relating to the count; and
storing the sorted counts.

17. The method of claim 16, wherein the method is conducted each day for a plurality of days and the count is a daily count for each day for each unique identifier, the method further comprising the steps of:
summing the daily counts for each day for each unique identifier, wherein the sum is a running total of the for each unique identifier; and
sorting the running totals for each unique identifier from a highest running total to a lowest running total.

18. A computer readable medium containing instructions for performing the method of claim 16.

19. A system for generating a user profile, comprising:
a network operation center that transmits high-bandwidth content;
a broadband medium, connected to the network operation center, over which the high-bandwidth content is transmitted; and
a client, connected to the broadband medium, that receives the high-bandwidth content, wherein the client comprises:
a memory that stores instructions for performing the method of claim 16; and
a processor that executes the instructions stored on the memory.

20. A method of filtering and displaying multiple advertising based on a user profile, comprising the steps of:
(a) receiving multiple advertising at a client via a broadband medium, wherein the multiple advertising includes a package of a plurality of advertisements;
(b) correlating the multiple advertising with a user profile, wherein each of the advertisements of the multiple advertising are correlated with the user profile;
(c) ranking each advertisement based on the correlation of the advertisement with the user profile, wherein the sorted advertisements are ranked from a highest ranking to a lowest ranking so that the advertisement with the highest correlation is placed at the highest ranking; and
(d) displaying a subset of the advertisements of the multiple advertising with high-bandwidth content, wherein the subset is chosen based on the ranking of the advertisements.

21. The method of claim 20, wherein the correlating step assigns a score to each advertisement based on the advertisement's correlation to the user profile, wherein a highest score represents a greatest correlation.

22. The method of claim 20, wherein the ranking step ranks each advertisement based on the advertisement's assigned score.

23. The method of claim 20, wherein step (d) displays the subset of advertisements as banner ads on a window on a display device of the client.

24. The method of claim 20, wherein:
the high-bandwidth content is displayed in a first window on a display device of the client; and
step (d) displays the subset of advertisements in a second window on the display device.

25. The method of claim 20, wherein the high-bandwidth content has commercial breaks and step (d) displays the subset of advertisements during the commercial breaks.

26. The method of claim 20, wherein step (d) displays the subset of advertisements on a rotational basis, periodically displaying a different advertisement.

27. The method of claim 20, further comprising the step of transmitting the multiple advertising from a signal origination point to a broadband service provider.

28. The method of claim 20, further comprising the step of:
storing the displayed subset of advertisements on a secondary storage device of the client.

29. The method of claim 20, further comprising the step of:
deleting a remaining subset of advertisements.

30. The method of claim 20, wherein the received multiple advertising is a first set of multiple advertising and the method further comprising the steps of:
receiving a second set of multiple advertising; and
filtering the second set of multiple advertising, whereby steps (b), (c), and (d) are repeated with the second set of multiple advertising.

31. The method of claim 30, wherein the filtering step filters the second set of multiple advertising with the first set of multiple advertising.

32. A computer readable medium containing instructions for performing the method of claim 20.

33. A system for delivering multiple advertising, comprising:
a network operation center that transmits high-bandwidth content and multiple advertising;
a broadband medium, connected to the network operation center, over which the high-bandwidth content and the multiple advertising are transmitted; and
a client, connected to the broadband medium, that receives the high-bandwidth content and the multiple advertising, wherein the client comprises:
a memory that stores instructions for performing the method of claim 20; and
a processor that executes the instructions stored on the memory.
